(19) United States
(12) Patent Application Publication
(10) Pub. No.: US 2025/0029774 A1
(43) Pub. Date: Jan. 23, 2025

(54) COIL COMPONENT

(71) Applicant: TDK Corporation, Tokyo (JP)

(72) Inventors: Yuya Oshima, Tokyo (JP); Kouichi Kakuda, Tokyo (JP); Kenji Komorita, Tokyo (JP); Takuya Niibori, Tokyo (JP); Shinichi Kondo, Tokyo (JP); Shigeshi Osawa, Yurihonjo-city (JP); Kaori Sasaki, Tokyo (JP); Makoto Yoshino, Tokyo (JP); Kazuma Sugawara, Tokyo (JP)

(73) Assignee: TDK Corporation, Tokyo (JP)

(21) Appl. No.: 18/772,848

(22) Filed: Jul. 15, 2024

(30) Foreign Application Priority Data
Jul. 21, 2023 (JP) 2023-118943

(51) Int. Cl. H01F 27/28; H01F 27/29

(52) U.S. Cl. CPC H01F 27/2847; H01F 27/29

(57) ABSTRACT

A coil component includes an element body including a pair of end surfaces opposing each other, and a coil disposed in the element body. The coil includes at least one coil conductor. The element body includes a pair of first element body portions each including a corresponding end surface of the pair of end surfaces, and a second element body portion between the pair of first element body portions. The second element body portion includes a first region and a second region disposed at positions different from each other in the direction. The second region has relative permeability smaller than relative permeability of the first region and relative permittivity smaller than relative permittivity of the first region. The at least one coil conductor includes a coil conductor disposed in the second element body portion.

### CROSS-REFERENCE TO RELATED APPLICATIONS

This application is based upon and claims the benefit of priority from Japanese Patent Application No. 2023-118943, filed on Jul. 21, 2023. The entire contents of which are incorporated herein by reference.

### BACKGROUND

### Field

The present disclosure relates to a coil component.

### Description of the Related Art

Known coil components include an element body and a coil disposed in the element body (for example, refer to Japanese Unexamined Patent Publication No. H8-55726). The element body includes a pair of end surfaces opposing each other. The coil is disposed such that a coil axis is along a direction in which the pair of end surfaces oppose each other.

### SUMMARY

One aspect of the present disclosure provides a coil component that has an impedance peak in a high frequency band and prevents a decrease in inductance.

A coil component according to one aspect of the present disclosure includes an element body including a pair of end surfaces opposing each other, and a coil disposed in the element body. The coil includes at least one coil conductor, and is disposed such that a coil axis is along in a direction in which the pair of end surfaces oppose each other. The element body includes a pair of first element body portions each including a corresponding end surface of the pair of end surfaces, and a second element body portion between the pair of first element body portions. The second element body portion includes a first region and a second region disposed at positions different from each other in the direction. The second region has relative permeability smaller than relative permeability of the first region and relative permittivity smaller than relative permittivity of the first region. The at least one coil conductor includes a coil conductor disposed in the second element body portion.

In the one aspect described above, the at least one coil conductor includes the coil conductor disposed in the second element body portion, and the second element body portion is reliably disposed at a position through which a magnetic flux generated by the coil conductor passes. The second element body portion affects characteristics of the coil component such as impedance and inductance. The second region has relative permeability smaller than relative permeability of the first region and relative permittivity smaller than relative permittivity of the first region. The second element body portion includes the second region. Therefore, the one aspect described above causes an impedance peak to appear in a high frequency band. The second element body portion includes the first region. Therefore, the one aspect described above prevents a decrease in inductance.

In the one aspect, the second region may include a portion positioned at a center of three portions obtained through trisecting the second element body portion in the direction.

In a configuration in which the second region includes the portion positioned at the center, the second region causes the coil component to have an impedance peak in the high frequency band. Therefore, this configuration reliably has the impedance peak in the high frequency band.

In the one aspect, each of the three portions may include a first region and a second region.

In a configuration in which each of the three portions includes the first region and the second region, the second region that has the impedance peak in the high frequency band is disposed in each of the three portions. Therefore, this configuration more reliably has the impedance peak in the high frequency band.

In the one aspect, the second region may include a plurality of regions disposed at different positions in the direction.

In a configuration in which the second region includes the plurality of regions, a plurality of second regions that have the impedance peak in the high frequency band are disposed in the second element body portion. Therefore, this configuration more reliably has the impedance peak in the high frequency band.

In the one aspect, the plurality of regions may be positioned symmetrically relative to a central position of a length of the second element body portion in the direction.

In a configuration in which the plurality of regions are positioned symmetrically relative to the central position, the plurality of second regions that have the impedance peak in the high frequency band are positioned symmetrically relative to the central position. Therefore, this configuration more reliably has the impedance peak in the high frequency band.

In the one aspect, the plurality of regions may be positioned with substantially equal intervals in the direction.

In a configuration in which the plurality of regions are positioned with substantially equal intervals in the direction, the plurality of second regions that have the impedance peak in the high frequency band are positioned with substantially equal intervals. Therefore, this configuration more reliably has the impedance peak in the high frequency band.

In the one aspect, the plurality of regions may be closer to one first element body portion of the pair of first element body portions. In a configuration in which the plurality of regions are closer to one first element body portion of the pair of first element body portions, even when an element included in the second region diffuses into the second element body portion, the element tends not to diffuse into a second element body portion close to another first element body portion. A first region positioned in the second element body portion close to another first element body portion tends not to be affected by the element diffusion. Therefore, this configuration reliably prevents the decrease in inductance.

In the one aspect, the at least one coil conductor may include a plurality of coil conductors. The plurality of coil conductors may include the coil conductor disposed in the second element body portion.

In a configuration including the coil conductor in which the plurality of coil conductors are disposed in the second region, the plurality of coil conductors can be disposed in the second region. Therefore, the plurality of coil conductors realizes the impedance peak in the high frequency band. As a result, this configuration more reliably has the impedance peak in the high frequency band.

In the one aspect, a pair of external electrodes disposed at both ends of the element body in the direction and electrically connected to the coil may be included. The element body may include side surfaces coupling the pair of end surfaces. Each of the pair of external electrodes may include an electrode portion positioned on the side surface. The second region is in contact with an edge of the electrode portion.

A configuration in which the edge of the electrode portion and the second region are in contact with each other reduces stray capacitance between the coil and the external electrode. Therefore, this configuration more reliably has the impedance peak in the high frequency band.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view illustrating a coil component according to an example;

FIG. 2 is an exploded perspective view illustrating a coil and connecting portions;

FIG. 3 is a view illustrating a cross-sectional configuration of the coil component according to the example;

FIG. 4 is a view illustrating a cross-sectional configuration of a coil component according to a first modification of the example;

FIG. 5 is a view illustrating a cross-sectional configuration of a coil component according to a second modification of the example;

FIG. 6 is a view illustrating a cross-sectional configuration of a coil component according to a third modification of the example;

FIG. 7 is a view illustrating a cross-sectional configuration of a coil component according to a fourth modification of the example;

FIG. 8 is a view illustrating a cross-sectional configuration of a coil component according to a fifth modification of the example;

FIG. 9 is a view illustrating a cross-sectional configuration of a coil component according to a sixth modification of the example;

FIG. 10 is a view illustrating a cross-sectional configuration of a coil component according to a seventh modification of the example;

FIG. 11 is a view illustrating a cross-sectional configuration of a coil component according to an eighth modification of the example; and

FIG. 12 is a view illustrating a cross-sectional configuration of a coil component according to a ninth modification of the example.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

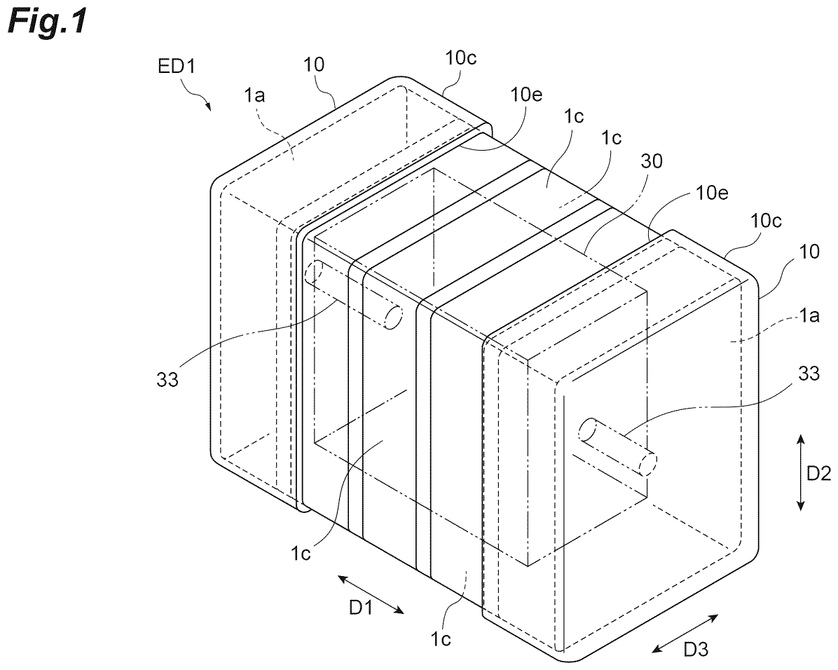

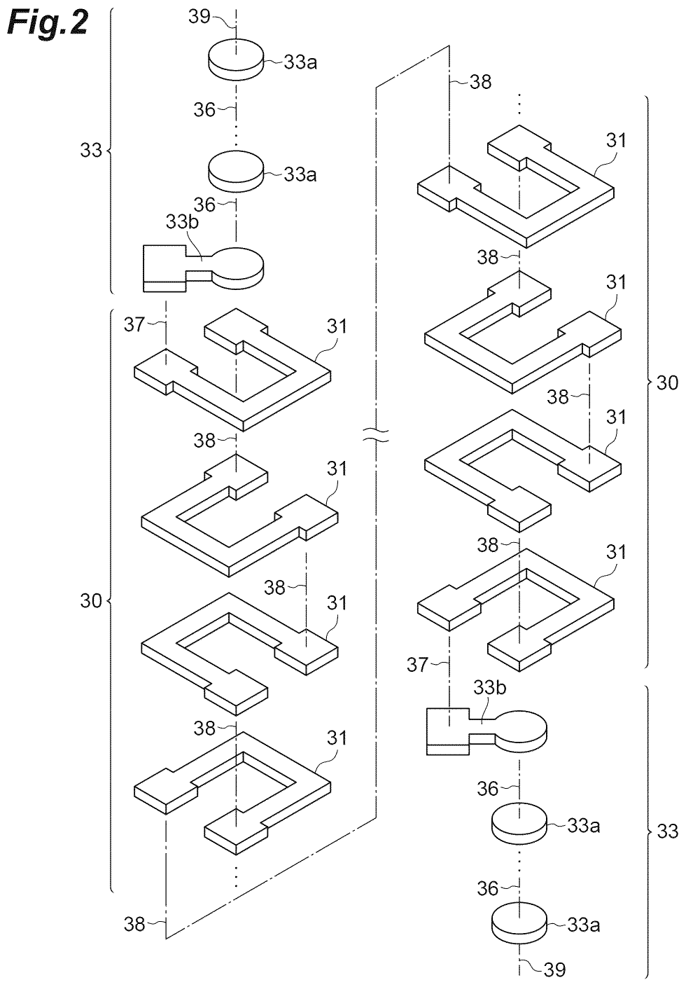

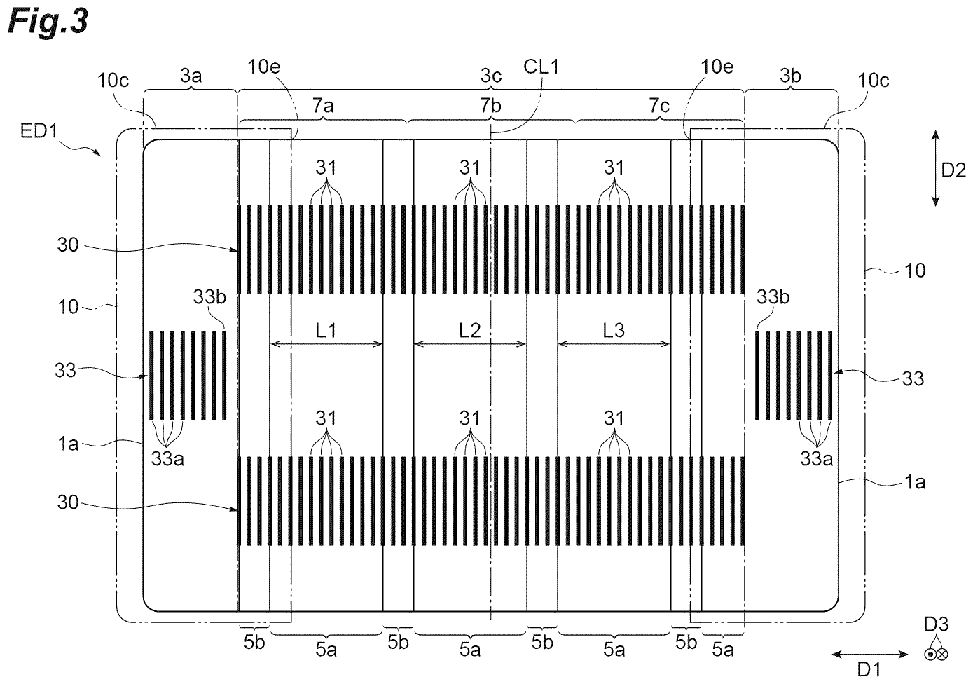

A configuration of a coil component ED1 according to an example will be described with reference to FIGS. 1 to 3. FIG. 1 is a perspective view illustrating a coil component according to the example. FIG. 2 is an exploded perspective view illustrating a coil and connecting portions. FIG. 3 is a view illustrating a cross-sectional configuration of the coil component according to the example. In FIG. 3, hatching indicating a cross section is omitted.

As illustrated in FIGS. 1 to 3, the coil component ED1 includes an element body 1, a pair of external electrodes 10, and a coil 30. The pair of external electrodes 10 are disposed on a surface of the element body 1. The coil 30 is disposed in the element body 1 and is electrically connected to the pair of external electrodes 10. The coil 30 is disposed such that the coil axis is along a first direction D1.

The element body 1 has, for example, a rectangular parallelepiped shape. For example, the rectangular parallelepiped shape includes the rectangular parallelepiped shape in which corners and ridges are chamfered, or the rectangular parallelepiped shape in which corners and ridges are rounded. The element body 1 includes a pair of end surfaces 1a opposing each other and four side surfaces 1c coupling the pair of end surfaces 1a. The surface of the element body 1 includes the pair of end surfaces 1a and the four side surfaces 1c. Each of the pair of end surfaces 1a and the four side surfaces 1c has a rectangular shape. For example, the rectangular shape includes, for example, a shape in which each corner is chamfered or a shape in which each corner is rounded.

The pair of end surfaces 1a oppose each other in the first direction D1. Of the four side surfaces 1c, one pair of side surfaces 1c oppose each other in a second direction D2. Another pair of side surfaces 1c oppose each other in a third direction D3. The four side surfaces 1c extend in the first direction D1 to couple the pair of end surfaces 1a. The first direction D1 intersects the second direction D2 and intersects the third direction D3. The second direction D2 intersects, for example, the third direction D3. For example, the first direction D1, the second direction D2, and the third direction D3 are orthogonal to each other.

A length of the element body 1 in the first direction D1 is, for example, 0.4 to 1.6 mm. A length of the element body 1 in the second direction D2 is, for example, 0.2 to 1.0 mm. A length of the element body 1 in the third direction D3 is, for example, 0.2 to 0.8 mm. In the element body 1, for example, the first direction D1 includes a longitudinal direction.

The pair of external electrodes 10 are disposed at both ends of the element body 1. One external electrode 10 is disposed, for example, on one end surface 1a. Another external electrode 10 is disposed, for example, on another end surface 1a. The pair of external electrodes 10 are separated from each other in the first direction D1. Each of the pair of external electrodes 10 includes an electrode portions 10c positioned on the four side surfaces 1c.

Each of the electrode portions 10c is positioned on the four side surfaces 1c. Each of the electrode portion 10c includes an edge 10e. One electrode portion 10c extends on the four side surfaces 1c, for example, from the one end surface 1a to the edge 10e included in the one electrode portion 10c in a direction toward the other end surface 1a. Another electrode portion 10c extends on the four side surfaces 1c, for example, from the other end surface 1a to the edge 10e included in the other electrode portion 10c in a direction toward the one end surface 1a. Each of the edges 10e is positioned on the four side surfaces 1c.

The external electrode 10 includes a conductive material. The conductive material includes, for example, Ag, Pd, Cu, or Al. The conductive material includes, for example, an Ag—Pd alloy, an Ag—Cu alloy, an Ag—Au alloy, or an Ag—Pt alloy. The external electrode 10 includes, for example, a Ni plating film, a Sn plating film, a Cu plating film, or an Au plating film. The external electrode 10 may have a multilayer structure of these plating films, and may include a Ni plating film and a Sn plating film formed on the Ni plating film. A thickness of a portion, of the external electrode 10, positioned on the end surface 1a is, for example, 5 to 50 μm.

The coil 30 includes a plurality of coil conductors 31. The coil 30 may include at least one coil conductor 31. The coil conductors 31 are disposed to at least partially overlap each other when viewed in the first direction D1. Each coil conductor 31 has, for example, a shape in which a part of a loop is interrupted. Each coil conductor 31 includes a pair of ends. Each coil conductor 31 extends along an annular path between the pair of ends. Of the plurality of coil conductors 31, coil conductors 31 adjacent to each other are connected to each other via a through-hole conductor 38 at the end of each coil conductor 31. When viewed in the first direction D1, the coil conductors 31 adjacent to each other overlap each other at corresponding ends. The coil component ED1 includes a pair of connecting portions 33 disposed at both ends of the coil 30. The pair of connecting portions 33 electrically connect the coil 30 and the pair of external electrodes 10. In FIG. 1, a two-dot chain line schematically illustrates outlines of outer shapes of the coil 30 and the connecting portions 33.

As illustrated in FIG. 2, each of the pair of connecting portions 33 includes, for example, a plurality of conductors 33a and one conductor 33b. Conductors 33a, among the plurality of conductors 33a, adjacent to each other are connected to each other via the through-hole conductor 36. The through-hole conductor 36 electrically connects the conductors 33a adjacent to each other, and the conductor 33a is not exposed on the end surface 1a, for example. In a configuration where the conductor 33a is not exposed on the end surface 1a, for example, a conductor 33a farthest from the coil 30 of the plurality of conductors 33a is connected to the external electrode 10 via the through-hole conductor 39. For example, the through-hole conductor 39 is disposed between the conductor 33a farthest from the coil 30 and the external electrode 10, and electrically connects the conductor 33a farthest from the coil 30 and the external electrode 10 to each other. The conductor 33a farthest from the coil 30 may be exposed on the end surface 1a. In a configuration where the conductor 33a is exposed on the end surface 1a, the conductor 33a exposed on the end surface 1a is directly connected to the external electrode 10, and each of the pair of connecting portions 33 does not include the through-hole conductor 39. The coil component ED1 may have a configuration in which one connecting portion 33 of the pair of connecting portions 33 includes the through-hole conductor 39 and another connecting portion 33 of the pair of connecting portions 33 does not include the through-hole conductor 39. In the configuration where the one connecting portion 33 includes the through-hole conductor 39 and the other connecting portion 33 does not include the through-hole conductor 39, the one connecting portion 33 is connected to the external electrode 10 at the through-hole conductor 39. The other connecting portion 33 is connected to the external electrode 10 at the conductor 33a exposed on the end surface 1a.

The conductor 33b is disposed between the coil 30 and the conductor 33a closest position to the coil 30. The conductor 33b electrically connects the plurality of conductors 33a and the coil 30. The conductor 33b includes, for example, one end connected to the conductor 33a and another end connected to the coil 30. The one end of the conductor 33b is connected to the conductor 33a via the through-hole conductor 36. The other end of the conductor 33b is connected to the coil 30 via a through-hole conductor 37. Of the plurality of coil conductors 31 included in the coil 30, a coil conductor 31 closest to the end surface 1a is connected to the conductor 33b via the through-hole conductor 37. In FIG. 2, a part of the plurality of conductors 33a and the through-hole conductors 36 are not illustrated.

The coil 30 and the connecting portion 33 include a conductive material. The conductive material includes, for example, Ag, Pd, Au, Cu, or Al. The conductive material includes, for example, an Ag—Pd alloy, an Ag—Cu alloy, an Ag—Au alloy, or an Ag—Pt alloy. The coil 30 and the connecting portion 33 include, for example, the same conductive material as the external electrode 10. The coil 30 and the connecting portion 33 may include a conductive material different from that of the external electrode 10.

The element body 1 includes a pair of element body portions 3a and 3b and an element body portion 3c. The pair of element body portions 3a and 3b each include a corresponding end surface 1a of the pair of end surfaces 1a. The element body portion 3a includes the one end surface 1a, and the element body portion 3b includes the other end surface 1a. The element body portion 3c is disposed between the element body portion 3a and the element body portion 3b in the first direction D1. The one connecting portion 33 is disposed in the element body portion 3a. The other connecting portion 33 is disposed in the element body portion 3b. The coil 30 is disposed in the element body portion 3c. In FIG. 3, illustration of the through-hole conductor 36 is omitted.

For example, when the element body portion 3a includes a first element body portion, the element body portion 3c includes a second element body portion. For example, when the element body portion 3b includes a first element body portion, the element body portion 3c includes a second element body portion.

The element body 1 includes, for example, a plurality of insulator layers having electrical insulation properties. The element body 1 includes a plurality of insulator layers laminated in the first direction D1. In the actual element body 1, the plurality of insulator layers are integrated to such an extent that boundaries between the insulator layers cannot be visually recognized. Each of the plurality of insulator layers has, for example, a rectangular shape when viewed in the first direction D1. Each of the plurality of coil conductors 31 and the conductors 33a and 33b is disposed between adjacent insulator layers of the plurality of insulator layers.

A boundary between each of the element body portions 3a and 3b and the element body portion 3c may be defined as follows.

For example, a plane defining a boundary between the element body portion 3a and the element body portion 3c is parallel to the one end surface 1a, and this plane is in contact with the surface included in the coil conductor 31 closest to the one end surface 1a and opposing the one end surface 1a. For example, a plane defining a boundary between the element body portion 3b and the element body portion 3c is parallel to the other end surface 1a, and this plane is in contact with the surface included in the coil conductor 31 closest to the other end surface 1a and opposing the other end surface 1a.

The element body portion 3c includes a plurality of regions 5a and a plurality of regions 5b. The element body portion 3c includes, for example, four regions 5a and four regions 5b. The four regions 5a and the four regions 5b are disposed at positions different from each other in the first direction D1. The regions 5a and 5b are alternately positioned in the first direction D1, for example. Each of the regions 5a and 5b includes an insulator layer. For example, when the region 5a includes a first region, the region 5b includes a second region.

The four regions 5b are positioned with intervals L1, L2, and L3 in a direction which is directed from the element body portion 3a toward the element body portion 3b along the first direction D1. Two regions 5b close to the element body portion 3a relative to a central position CL1 are separated from each other at the interval L1. Two regions 5b positioned in the central are separated from each other at the interval L2. Two regions 5b close to the element body portion 3b relative to the central position CL1 are separated from each other at the interval L3. The intervals L1, L2, and L3 are substantially the same. The four regions 5b are positioned with substantially equal intervals in the first direction D1.

For example, “substantially equal intervals” include a plurality of intervals being equal to each other, a difference between the plurality of intervals being within a range of a predetermined slight difference, or a difference between the plurality of intervals being within a making error. For example, when each of the plurality of intervals L1, L2, and L3 falls within a range of ±20% of an average value of the plurality of intervals L1, L2, and L3, the plurality of regions 5b are regarded as being positioned with substantially equal intervals.

One edge 10e of the electrode portion 10c and the region 5b are in contact with each other, for example. The one edge 10e and one region 5b closest to the element body portion 3a of the plurality of regions 5b are in contact with each other. The region 5b closest to the element body portion 3a is covered with the one electrode portion 10c. The other edge 10e and one region 5b closest to the element body portion 3b are in contact with each other. The region 5b closest to the element body portion 3b is covered with the other electrode portion 10c. The two regions 5b positioned in the central position are not in contact with the edge 10e, for example. The two regions 5b positioned in the central position are exposed from the electrode portions 10c, for example.

In the element body portion 3c, an insulator layer included in the region 5a includes a first material. The first material includes, for example, a ferrite material. The ferrite material included in the first material includes, for example, a Ni—Cu—Zn based ferrite material, a Mg—Cu—Zn based ferrite material, a Ni—Cu—Zn—Mg based ferrite material, or a Ni—Cu based ferrite material. An insulator layer included in the region 5b includes a second material. The second material includes, for example, a Ni—Cu—Zn based ferrite material, a Mg—Cu—Zn based ferrite material, a Ni—Cu—Zn—Mg based ferrite material, a Ni—Cu based ferrite material, a Cu—Zn based ferrite material, a glass based material, a forsterite material, a willemite material, an alumina material, a cordierite material, a steatite material, or a mullite material, or a material obtained through mixing these materials.

The second material includes a material having relative permeability smaller than relative permeability of the first material and relative permittivity smaller than relative permittivity of the first material. Therefore, the second material may include a magnetic material when it includes a material having relative permeability smaller than relative permeability of the first material and relative permittivity smaller than relative permittivity of the first material. The insulator layers disposed in the element body portions 3a and 3b include, for example, the first material.

The relative permeability of the first material is, for example, 2 to 1500. The relative permeability of the second material included in the region 5b is, for example, 1 to 10. The relative permeability of the second material included in the region 5b is, for example, 1. The relative permittivity of the first material is, for example, 8 to 20. The relative permittivity of the second material included in the region 5b is, for example, 3 to 15.

The region 5b has relative permeability smaller than relative permeability of the region 5a and relative permittivity smaller than relative permittivity of the region 5a. The relative permeability of the region 5b is smaller than relative permeability of the region 5a, and the relative permittivity of the region 5b is smaller than relative permittivity of the region 5a.

The element body portion 3c includes three portions of a portion 7a, a portion 7b, and a portion 7c. The portion 7a, the portion 7b, and the portion 7c are positioned in the order of, for example, the portion 7a, the portion 7b, and the portion 7c in the first direction D1. The portion 7b is positioned at a center of the portions 7a, 7b, and 7c. The portion 7a is positioned near the element body portion 3a. The portion 7c is positioned near the element body portion 3b. For example, the portions 7a, 7b, and 7c are obtained through trisecting the element body portion 3c in the first direction D1.

For example, “trisecting” includes that lengths of the three portions are equal to each other, that a difference between the lengths of the three portions falls within a range of a preset minute difference, or that a difference between the lengths of the three portions falls within a making error. For example, when the lengths of the portions 7a, 7b, and 7c in the first direction D1 fall within a range of +20% of an average value of the lengths of the portions 7a, 7b, and 7c in the first direction D1, the portions 7a, 7b, and 7c are regarded as being obtained through trisecting the element body portion 3c in the first direction D1.

Each of the portions 7a, 7b, and 7c includes, for example, at least one region 5a and at least one region 5b. The portion 7a includes one region 5a and two regions 5b. The portion 7b includes two regions 5a and two regions 5b. The portion 7c includes two regions 5a and one region 5b. Each of the portions 7a and 7b adjacent to each other includes either one of the regions 5a and 5b positioned at the boundary between the portions 7a and 7b. Each of the portions 7b and 7c adjacent to each other includes either one of the regions 5a and 5b positioned at the boundary between the portions 7b and 7c. In each of the plurality of regions 5b, three insulator layers including the second material are continuously laminated to each other without interposing the region 5a.

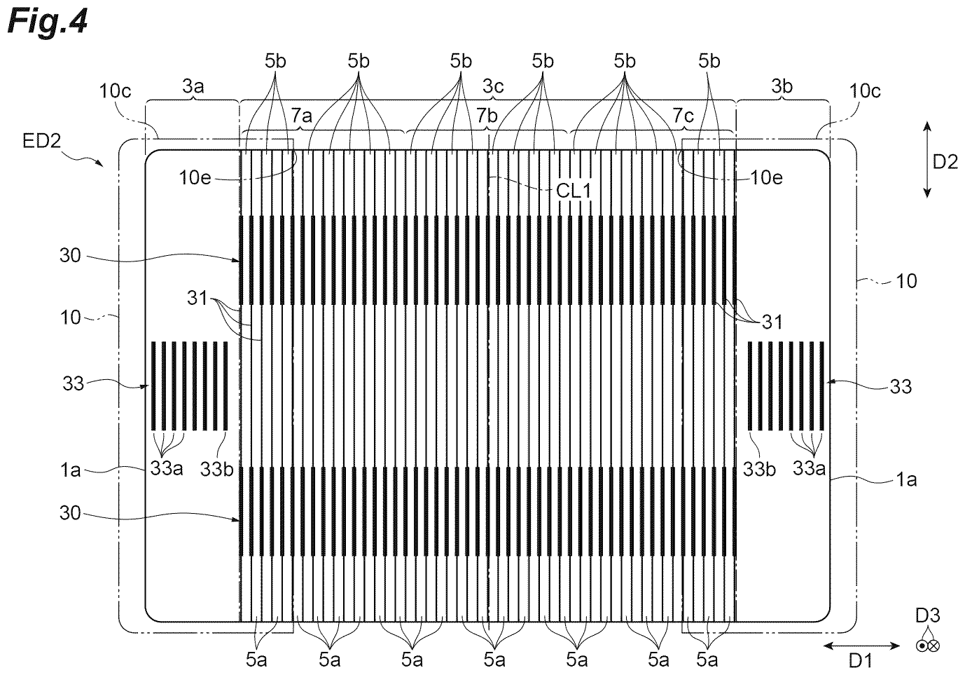

A coil component ED2 according to a first modification of the example will be described with reference to FIG. 4. FIG. 4 is a view illustrating a cross-sectional configuration of a coil component according to a first modification of the example. In FIG. 4, hatching indicating a cross section and illustration of the through-hole conductor 36 are omitted. The coil component ED2 is the same as the coil component ED1 except for the positions of the regions 5a and 5b.

The element body portion 3c includes 24 regions 5a and 24 regions 5b. The 24 regions 5b are disposed at different positions in the first direction D1. Each of the portions 7a, 7b, 7c includes eight regions 5a and eight regions 5b.

In the coil component ED2, the 24 regions 5b are positioned with substantially equal intervals in the first direction D1. For example, one insulator layer included in the region 5b and one insulator layer included in the region 5a are alternately laminated. The one edge 10e and three regions 5b close to the element body portion 3a are in contact with each other. The other edge 10e and two regions 5b close to the element body portion 3b are in contact with each other. For example, regions 5b other than the five regions 5b are not in contact with the edge 10e and are exposed from the electrode portion 10c.

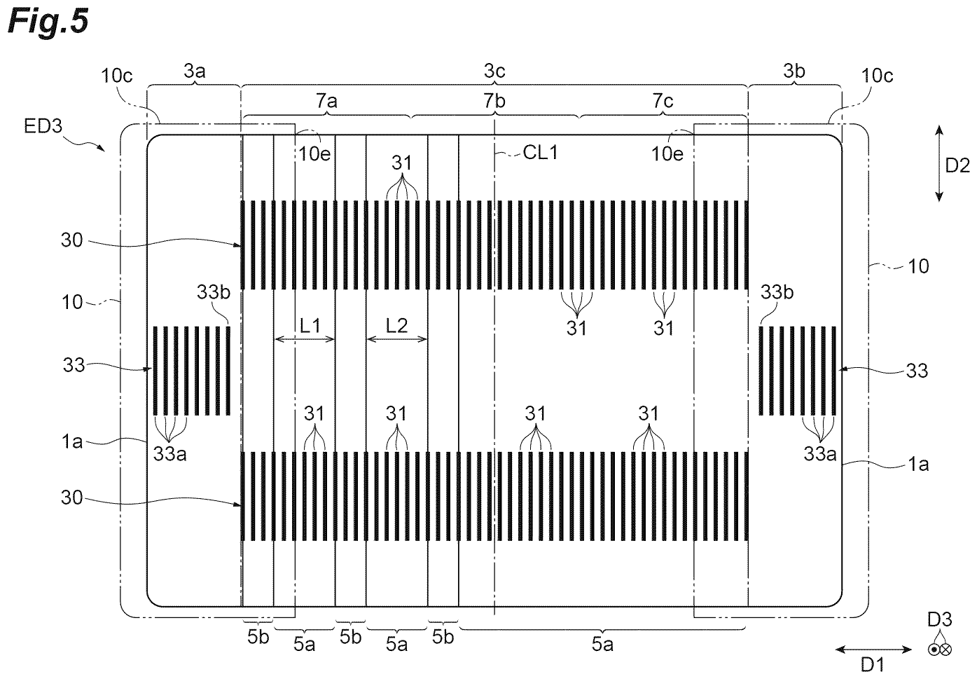

A coil component ED3 according to a second modification of the example will be described with reference to FIG. 5. FIG. 5 is a view illustrating a cross-sectional configuration of a coil component according to a second modification of the example. In FIG. 5, hatching indicating a cross section and illustration of the through-hole conductor 36 are omitted. The coil component ED3 is the same as the coil component ED1 except for the positions of the regions 5a and 5b.

The element body portion 3c includes three regions 5a and three regions 5b. The three regions 5b are disposed at different positions in the first direction D1. The portion 7a includes two regions 5a and two regions 5b. The portion 7b includes two regions 5a and one region 5b. The portion 7c includes one region 5a and does not include the region 5b.

In the coil component ED3, each of the three regions 5b is closer to the element body portion 3a. The three regions 5b are positioned near the element body portion 3a relative to the central position CL1. The three regions 5b are positioned with intervals L1 and L2 in a direction that is directed from the element body portion 3a toward the element body portion 3b along the first direction D1. For example, the intervals L1 and L2 are substantially the same. The three regions 5b are positioned with substantially equal intervals in the first direction D1. In each of the three regions 5b, three insulator layers including the second material are continuously laminated to each other without interposing the region 5a.

One edge 10e and one region 5b closest to the element body portion 3a of the three regions 5b are in contact with each other. Another edge 10e and the region 5b are not in contact with each other. Two regions 5b close to the element body portion 3b are not in contact with the edge 10e and are exposed from the electrode portion 10c.

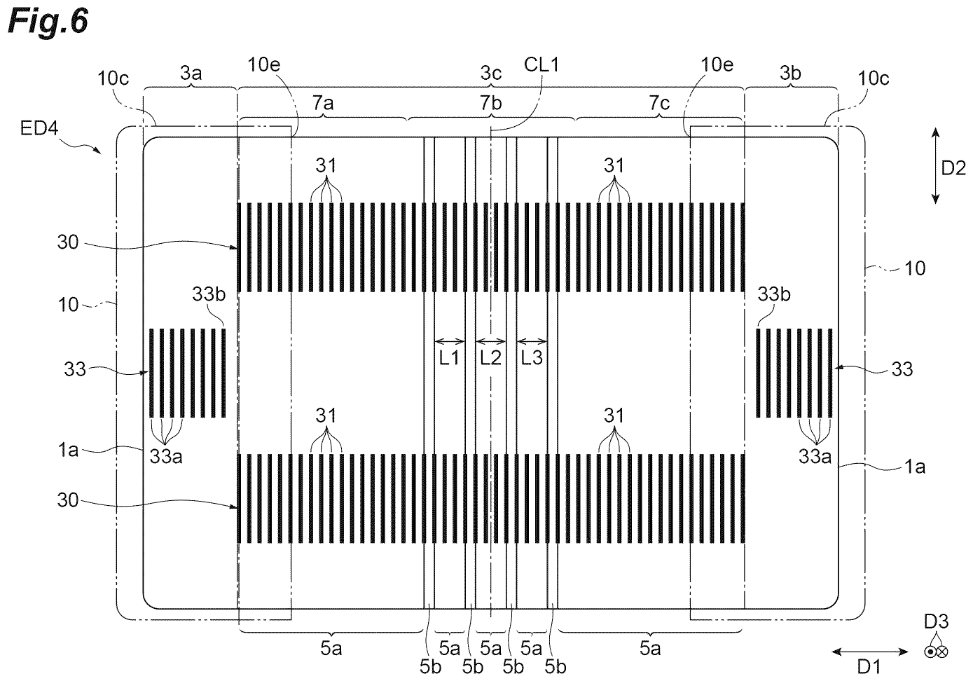

A coil component ED4 according to a third modification of the example will be described with reference to FIG. 6. FIG. 6 is a view illustrating a cross-sectional configuration of a coil component according to a third modification of the example. In FIG. 6, hatching indicating a cross section and illustration of the through-hole conductor 36 are omitted. The coil component ED4 is the same as the coil component ED1 except for the positions of the regions 5a and 5b.

The element body portion 3c includes five regions 5a and four regions 5b. The four regions 5b are disposed at different positions in the first direction D1. In the coil component ED4, the four regions 5b are positioned symmetrically relative to the central position CL1. The intervals between two regions 5b in the central position of the four regions 5b and the central position CL1 are substantially the same. The intervals between two regions 5b at both ends of the four regions 5b and the central position CL1 are substantially the same. Of the four regions 5b, the central position CL1 is between the two regions 5b positioned in the central position.

In the example illustrated in FIG. 6, each of the portions 7a and 7c includes one region 5a and does not include the region 5b. The portion 7b includes five regions 5a and four regions 5b. In the coil component ED4, each of the portions 7a and 7c may include the region 5b. For example, each of the portions 7a and 7c may include two regions 5a and one region 5b, and the portion 7b may include three regions 5a and two regions 5b. For example, each of the portions 7a and 7c may include three regions 5a and two regions 5b, and the portion 7b may include one region 5a and may not include the region 5b.

The four regions 5b are positioned with intervals L1, L2, and L3 in a direction that is directed from the element body portion 3a toward the element body portion 3b along the first direction D1. In the coil component ED4, the intervals L1, L2, and L3 are substantially the same. The four regions 5b are positioned with substantially equal intervals in the first direction D1.

In the four regions 5b, one insulator layers including the second material are continuously laminated on each other. The edge 10e and the region 5b are not in contact with each other. The four regions 5b are not in contact with the edge 10e and are exposed from the electrode portion 10c.

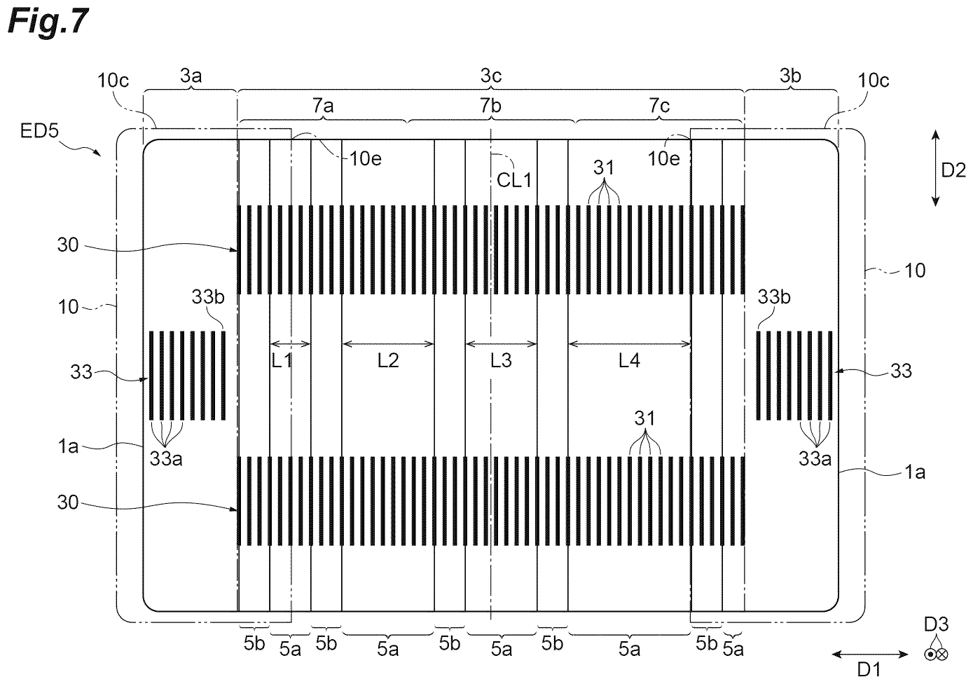

A coil component ED5 according to a fourth modification of the example will be described with reference to FIG. 7. FIG. 7 is a view illustrating a cross-sectional configuration of a coil component according to a fourth modification of the example. In FIG. 7, hatching indicating a cross section and illustration of the through-hole conductor 36 are omitted. The coil component ED5 is the same as the coil component ED1 except for the positions of the regions 5a and 5b.

The element body portion 3c includes four regions 5a and five regions 5b. The five regions 5b are disposed at different positions in the first direction D1. The portion 7a includes two regions 5a and two regions 5b. The portion 7b includes three regions 5a and two regions 5b. The portion 7c includes two regions 5a and one region 5b.

In the coil component ED5, the five regions 5b are not positioned symmetrically relative to the central position CL1. The five regions 5b are positioned with intervals L1, L2, L3, and L4 in a direction that is directed from the element body portion 3a toward the element body portion 3b along the first direction D1. In the fourth modification, the intervals L1, L2, L3, and L4 are different from each other. For example, the interval L4 is the largest, and the interval L2 is the second largest. Next, the interval L3 is the third largest, and the interval L1 is the smallest.

In each of the five regions 5b, three insulator layers including the second material are continuously laminated without interposing the region 5a.

In the coil component ED5, one edge 10e and one region 5b closest to the element body portion 3a of the five regions 5b are in contact with each other. The other edge 10e and one region 5b closest to the element body portion 3b are in contact with each other. For example, three regions 5b positioned second to fourth from the element body portion 3a are not in contact with the edge 10e and are exposed from the electrode portion 10c.

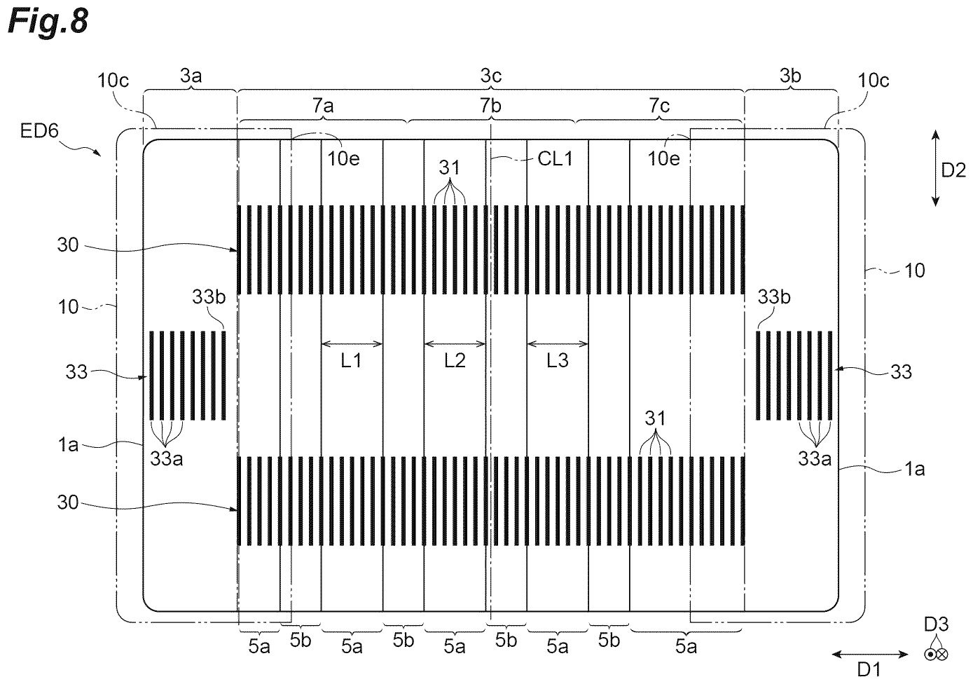

A coil component ED6 according to a fifth modification of the example will be described with reference to FIG. 8. FIG. 8 is a view illustrating a cross-sectional configuration of a coil component according to a fifth modification of the example. In FIG. 8, hatching indicating a cross section and illustration of the through-hole conductor 36 are omitted. The coil component ED6 is the same as the coil component ED1 except for the positions of the regions 5a and 5b.

The element body portion 3c includes five regions 5a and four regions 5b. The four regions 5b are disposed at different positions in the first direction D1. The portion 7a includes two regions 5a and two regions 5b. The portion 7b includes two regions 5a and two regions 5b. The portion 7c includes two regions 5a and one region 5b.

In the coil component ED6, the four regions 5b are not positioned symmetrically relative to the central position CL1. The four regions 5b are closer to the element body portion 3a. In each of the four regions 5b, four insulator layers including the second material are continuously laminated without interposing the region 5a. The four regions 5b are positioned with intervals L1, L2, and L3 in a direction that is directed from the element body portion 3a toward the element body portion 3b along the first direction D1. For example, the intervals L1, L2, and L3 are substantially the same. The four regions 5b are positioned with substantially equal intervals in the first direction D1.

One edge 10e and a part of the region 5b closest to the element body portion 3a of the four regions 5b are in contact with each other. The part of the region 5b closest to the element body portion 3a is covered with the one electrode portion 10c. The one edge 10e and the other portion of the region 5b closest to the element body portion 3a are not in contact with each other. The other portion of the region 5b closest to the element body portion 3a is not covered with one electrode portion 10c. The other edge 10e and the region 5b are not in contact with each other. Three regions 5b close to the element body portion 3b are not in contact with the edge 10e and are exposed from the electrode portion 10c.

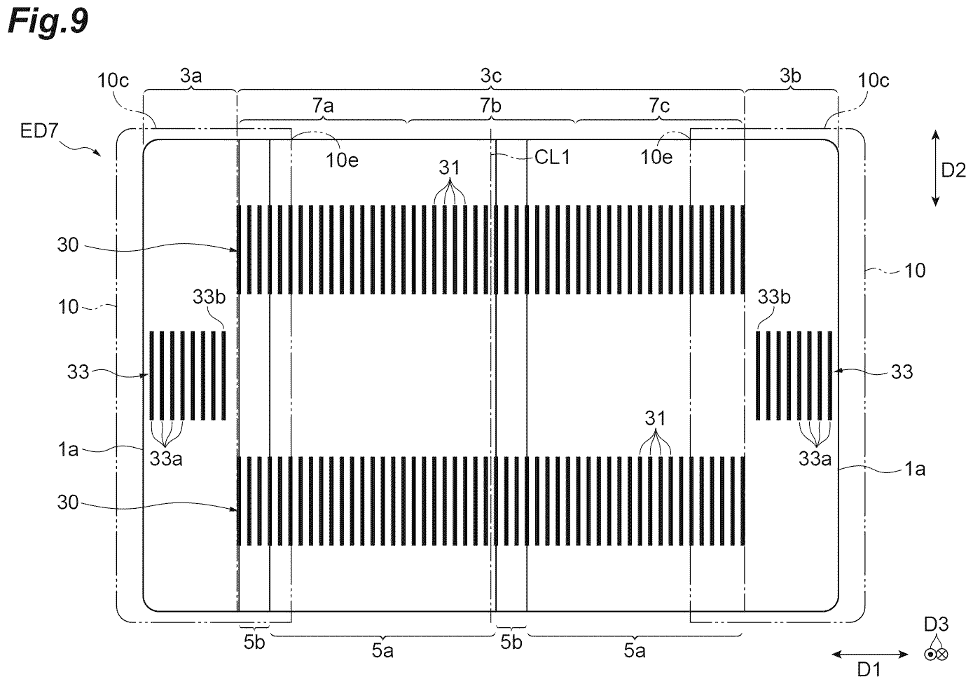

A coil component ED7 according to a sixth modification of the example will be described with reference to FIG. 9. FIG. 9 is a view illustrating a cross-sectional configuration of a coil component according to a sixth modification of the example. In FIG. 9, hatching indicating a cross section and illustration of the through-hole conductor 36 are omitted. The coil component ED7 is the same as the coil component ED1 except for the positions of the regions 5a and 5b.

The element body portion 3c includes two regions 5a and two regions 5b. The two regions 5b are disposed at different positions in the first direction D1. The portion 7a includes one region 5a and one region 5b. The portion 7b includes two regions 5a and one region 5b. The portion 7c includes one region 5a and does not include the region 5b.

In the coil component ED7, the two regions 5b are not positioned symmetrically relative to the central position CL1. The two regions 5b are positioned closer to the element body portion 3a. In each of the two regions 5b, three insulator layers including the second material are continuously laminated without interposing the region 5a.

One edge 10e and one region 5b close to the element body portion 3a of the two regions 5b are in contact with each other. The region 5b close to the element body portion 3a is covered with one electrode portion 10c. One region 5b close to the element body portion 3b is not in contact with the edge 10e and is exposed from the electrode portion 10c.

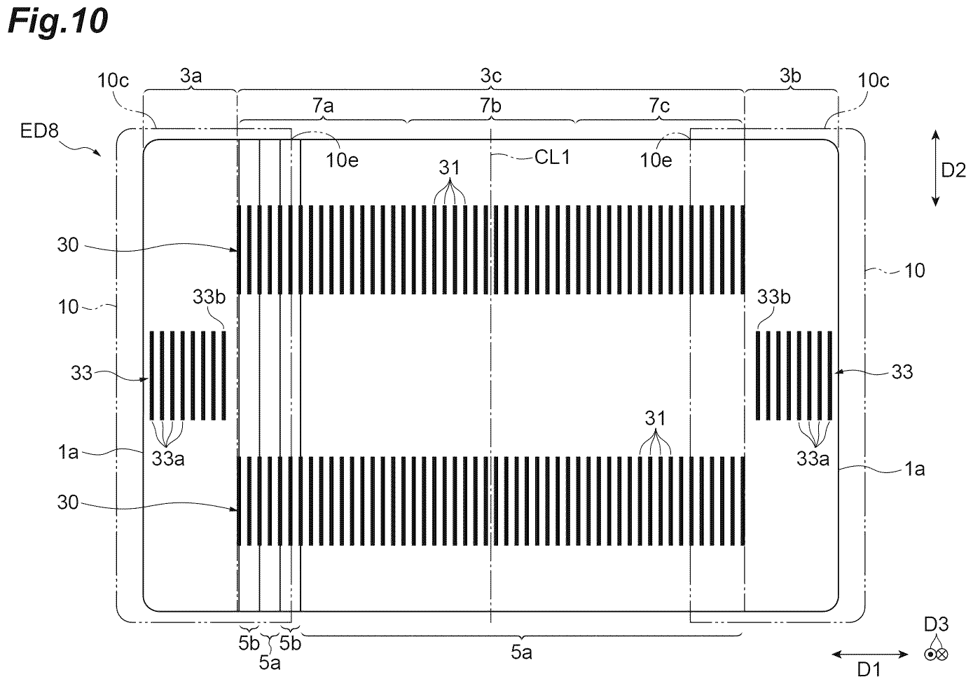

A coil component ED8 according to a seventh modification of the example will be described with reference to FIG. 10. FIG. 10 is a view illustrating a cross-sectional configuration of a coil component according to a seventh modification of the example. In FIG. 10, hatching indicating a cross section and illustration of the through-hole conductor 36 are omitted. The coil component ED8 is the same as the coil component ED1 except for the positions of the regions 5a and 5b.

The element body portion 3c includes two regions 5a and two regions 5b. The two regions 5b are disposed at different positions in the first direction D1. The portion 7a includes two regions 5a and two regions 5b. Each of the portions 7b and 7c includes one region 5a and does not include the region 5b.

In the coil component ED8, the two regions 5b are not positioned symmetrically relative to the central position CL1. The two regions 5b are closer to the element body portion 3a. In each of the two regions 5b, two insulator layers including the second material are continuously laminated without interposing the region 5a.

One edge 10e and one region 5b closest to the element body portion 3a of the two regions 5b are in contact with each other. The one edge 10e and a part of the region 5b positioned second from the element body portion 3a are in contact with each other. The region 5b closest to the element body portion 3a and the part of the region 5b positioned second from the element body portion 3a are covered with one electrode portion 10c. The one edge 10e and the other portion of the region 5b positioned second from the element body portion 3a are not in contact with each other. The other portion of the region 5b positioned second from the element body portion 3a is exposed from the one electrode portion 10c. The other edge 10e is not in contact with any region 5b. The other edge 10e does not cover any region 5b.

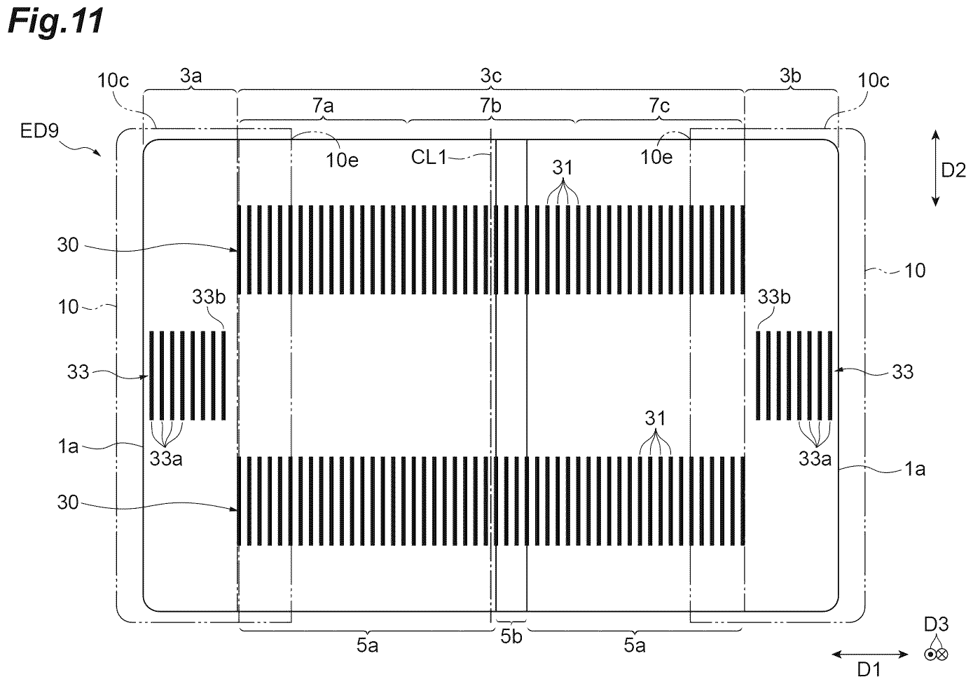

A coil component ED9 according to an eighth modification of the example will be described with reference to FIG. 11. FIG. 11 is a view illustrating a cross-sectional configuration of a coil component according to an eighth modification of the example. In FIG. 11, hatching indicating a cross section and illustration of the through-hole conductor 36 are omitted. The coil component ED9 is the same as the coil component ED1 except for the positions of the regions 5a and 5b.

The element body portion 3c includes two regions 5a and one region 5b. Each of the portions 7a and 7c includes one region 5a and does not include the region 5b. The portion 7b includes two regions 5a and one region 5b. In one region 5b, three insulator layers including the second material are continuously laminated to each other without interposing the region 5a. The one region 5b is not in contact with the edge 10e and is exposed from the electrode portion 10c.

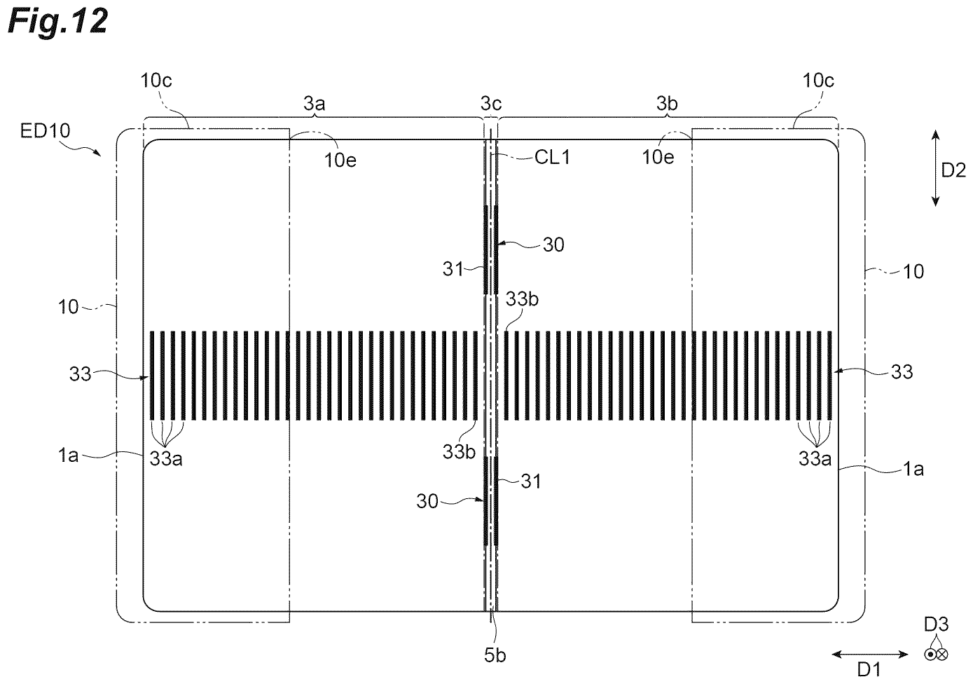

A coil component ED10 according to a ninth modification of the example will be described with reference to FIG. 12. FIG. 12 is a view illustrating a cross-sectional configuration of a coil component according to a ninth modification of the example. In FIG. 12, hatching indicating a cross section and illustration of the through-hole conductor 36 are omitted. The coil component ED10 is the same as the coil component ED1 except for the sizes of the element body portions 3a, 3b, and 3c, the configuration of the coil 30, and the positions of the regions 5a and 5b.

Each of the element body portions 3a and 3b is longer in the first direction D1 than the element body portions 3a and 3b according to the example. The number of coil conductors 31 included in the coil 30 according to the ninth modification is smaller than the number of coil conductors 31 included in the coil 30 according to the example. The element body portion 3c includes one region 5b. The one region 5b is not in contact with the edge 10e and is exposed from the electrode portion 10c.

As described above, in the coil components ED1 to ED10, at least one coil conductor 31 includes the coil conductor 31 disposed in the element body portion 3c, and the element body portion 3c is reliably disposed at a position through which the magnetic flux generated by the coil conductor 31 passes. The element body portion 3c affects the characteristics of the coil component such as impedance and inductance. The element body portion 3c includes one region 5a and one region 5b, and the region 5b has relative permeability smaller than relative permeability of the region 5a and relative permittivity smaller than relative permittivity of the region 5a. The element body portion 3c includes the region 5b. Therefore, the coil components ED1 to ED10 cause the impedance peak to appear in the high frequency band. The element body portion 3c includes the region 5a. Therefore, the coil components ED1 to ED10 prevent the decrease in inductance.

The coil components ED1 to ED10 have high impedance in the high frequency band of 700 MHz to 3 GHZ, for example.

In the coil components ED1 to ED7, ED9, and ED10, a portion 7b positioned at the center of three portions 7a, 7b, and 7c obtained through trisecting the element body portion 3b in the first direction D1 includes one region 5b.

In the coil components ED1 to ED7, ED9, and ED10, the region 5b includes the portion positioned at the center, the region 5b causes the coil component to have an impedance peak in the high frequency band. Therefore, the coil components ED1 to ED7, ED9, and ED10 reliably have impedance peaks in the high frequency band.

In the coil components ED1, ED2, ED5, and ED6, each of the three portions 7a, 7b, and 7c includes one region 5a and one region 5b.

In the coil components ED1, ED2, ED5, and ED6, the region 5b that has the impedance peak in the high frequency band is disposed in each of the three portions 7a, 7b, and 7c. Therefore, the coil components ED1, ED2, ED5, and ED6 more reliably have the impedance peaks in the high frequency band.

In the coil components ED1 to ED8, the element body portion 3c includes a plurality of regions 5b disposed at different positions in the first direction D1.

In the coil components ED1 to ED8, the plurality of regions 5b that have the impedance peaks in the high frequency band are disposed in the element body portion 3c. Therefore, the coil components ED1 to ED8 more reliably have the impedance peaks in the high frequency band.

In the coil component ED4, the plurality of regions 5b are positioned symmetrically relative to the central position CL1 of the element body portion 3c.

In the coil component ED4, the plurality of regions 5b that have the impedance peaks in the high frequency band are positioned symmetrically relative to the central position CL1. Therefore, the coil component ED4 more reliably has the impedance peak in the high frequency band.

In the coil components ED1 to ED4 and ED6, the plurality of regions 5b are positioned with substantially equal intervals in the first direction D1.

In the coil components ED1 to ED4 and ED6, the plurality of regions 5b that have impedance peaks in the high frequency band are positioned with substantially equal intervals. Therefore, the coil components ED1 to ED4 more reliably have the impedance peaks in the high frequency band.

In the coil components ED3, ED7, and ED8, the plurality of regions 5b are closer to one element body portion 3a of the pair of element body portions 3a and 3b.

In the coil components ED3, ED7, and ED8, even when the element included in the region 5b diffuses into the element body portion 3c, the element tends not to be diffused into the element body portion 3c close to the element body portion 3b. The region 5a positioned in the element body portion 3c close to the element body portion 3b tends not to be affected by the element diffusion. Therefore, the coil components ED3, ED7, and ED8 reliably prevents the decrease in inductance.

In the coil components ED4 and ED9, the portion 7b includes the region 5a, and the portions 7a and 7c do not include the region 5b. Even when the element contained in the region 5b diffuses into the element body portion 3c, the element tends not to diffuse into the element body portion 3c close to the element body portions 3a and 3b. The element body portion 3c close to the element body portions 3a and 3b tends not to be affected by the element diffusion. Therefore, the coil components ED4 and ED9 reliably prevents the decrease in inductance.

In the coil components ED1 to ED10, at least one coil conductor 31 includes a plurality of coil conductors 31. The plurality of coil conductors 31 include the coil conductor 31 disposed in the element body portion 3c.

In the coil components ED1 to ED10, the plurality of coil conductors 31 can be disposed in the region 5b. Therefore, the impedance peak in the high frequency band is realized by the plurality of coil conductors 31. As a result, the coil components ED1 to ED10 more reliably have the impedance peak in the high frequency band.

The coil components ED1 to ED3 and ED5 to ED8 include the pair of external electrodes 10 disposed at both ends of the element body 1 in the first direction D1 and electrically connected to the coil 30. The element body 1 includes side surfaces 1c coupling the pair of end surfaces 1a. One external electrode 10 includes an electrode portion 10c positioned on the side surfaces 1c. The edge 10e of one electrode portion 10c and the region 5b are in contact with each other. The other external electrode 10 includes the other electrode portion 10c positioned on the side surfaces 1c. The region 5b is in contact with the edge 10e of the other electrode portion 10c.

The coil components ED1 to ED3 and ED5 to ED8 reduce stray capacitance between the coil 30 and the external electrode 10. Therefore, the coil components ED1 to ED3 and ED5 to ED8 more reliably have the impedance peaks in the high frequency band.

Although the example and modifications of the present disclosure have been described above, the present disclosure is not necessarily limited to the above-described example and modifications, and various modifications can be made without departing from the gist thereof.

In the coil component ED1, only the portions 7a and 7c positioned at both ends of the three portions 7a, 7b, and 7c may include the region 5b. As described above, the configuration in which the portion 7b positioned at the center includes the region 5b reliably has the impedance peak in the high frequency band.

What is claimed is:

1. A coil component comprising:
an element body including a pair of end surfaces opposing each other; and
a coil disposed in the element body, wherein
the coil includes at least one coil conductor, and is disposed such that a coil axis is along a direction in which the pair of end surfaces opposes each other,
the element body includes a pair of first element body portions each including a corresponding end surface of the pair of end surfaces, and a second element body portion between the pair of first element body portions,
the second element body portion includes a first region and a second region disposed at positions different from each other in the direction,
the second region has relative permeability smaller than relative permeability of the first region and relative permittivity smaller than relative permittivity of the first region, and
the at least one coil conductor includes a coil conductor disposed in the second element body portion.

2. The coil component according to claim 1, wherein
the second region is included with a portion positioned at a center of three portions obtained through trisecting the second element body portion in the direction.

3. The coil component according to claim 2, wherein
each of the three portions includes the first region and the second region.

4. The coil component according to claim 1, wherein
the second region includes a plurality of regions disposed at different positions in the direction.

5. The coil component according to claim 4, wherein
the plurality of regions are positioned symmetrically relative to a central position of a length of the second element body portion in the direction.

6. The coil component according to claim 4, wherein
the plurality of regions are positioned with substantially equal intervals in the direction.

7. The coil component according to claim 4, wherein
the plurality of regions are closer to one first element body portion of the pair of first element body portions.

8. The coil component according to claim 1, wherein
the at least one coil conductor includes a plurality of coil conductors, and
the plurality of coil conductors include the coil conductor disposed in the second element body portion.

9. The coil component according to claim 1, further comprising:
a pair of external electrodes disposed at both ends of the element body in the direction and electrically connected to the coil, wherein
the element body includes side surfaces coupling the pair of end surfaces,
each of the pair of external electrodes includes an electrode portion positioned on the side surface, and
the second region is in contact with an edge of the electrode portion.
